(19) United States
(12) Patent Application Publication
(10) Pub. No.: US 2007/0022274 A1
(43) Pub. Date: Jan. 25, 2007

(54) Apparatus, system, and method of predicting and correcting critical paths

(76) Inventors: Roni Rosner, Binyamina (IL); Ari Schmorak, Haifa (IL); Simcha Gochman, Timrat (IL); Abraham Mendelson, Haifa (IL); Guillermo Savransky, Haifa (IL)

Correspondence Address: PEARL COHEN ZEDEK LATZER, LLP, 1500 BROADWAY, 12TH FLOOR, NEW YORK, NY, 10036, US

(21) Appl. No.: 11/168,491

(22) Filed: Jun. 29, 2005

(51) Int. Cl. G06F 15/00

(52) U.S. Cl. 712/220

(57) ABSTRACT

Embodiments of the invention provide a method that includes partitioning a series of instructions of a trace into a plurality of dependency sets before executing the trace; and marking a first group of the dependency sets as critical and a second group of the dependency sets as non-critical Embodiments of the invention also provide a method that may identify a dependency set in the second group, which delays the execution of at least one dependency set in the first group, as a delaying dependency set; counting the number of delays caused by the delaying dependency set; and re-marking the delaying dependency set as critical when a predefined delaying event threshold is reached. Embodiments of the invention also provide apparatus, system, and machine-readable medium thereof

### BACKGROUND OF THE INVENTION

A computer program code may be divided into multiple traces, and each trace may include a set of instructions. A trace may be executed along multiple instruction paths, and a path having the longest execution time, among the multiple paths, may be a critical path as is known in the art. Knowing the critical path of a computer program code and directing adequate machine resources, for example, processing capacity, towards the execution of the critical path may generally improve the execution speed of the program code.

Prior knowledge of a critical path, based on past execution experience, may be used, to a certain extent, to help improve the execution of a computer program code. However, a critical path is determined by a dynamic stream of instructions and for that reason a past critical path may not necessarily continue to be critical since it is based on past static instructions. For example, since delays in memory operations may not be statically predictable, a critical path may not be determined without actually knowing the memory operation condition.

Conventionally, a fully dynamic method may be used to predict a critical path of a program code. However, by this method, a critical path is predicted dynamically during code execution without reference to prior knowledge of criticality of various execution paths. Therefore, a fully dynamic method may not always be a preferred choice for predicting a critical path when performance of the method is measured by criteria such as, for example, simplicity for implementation, adaptability to other applications, and power efficiency during code execution.

### BRIEF DESCRIPTION OF THE DRAWINGS

The invention will be understood and appreciated more fully from the following detailed description of embodiments of the invention, taken in conjunction with the accompanying drawings of which:

FIG. 1 is a block diagram illustration of an apparatus capable of identifying a critical path of a computer program code according to some illustrative embodiments of the invention;

FIG. 2 is a schematic flowchart of a method of partitioning a trace into groups of dependency sets according to some illustrative embodiments of the invention;

FIG. 3 is a schematic flowchart of a method of updating the mark of a dependency set from non-critical to critical according to some illustrative embodiments of the invention;

FIG. 4 is a schematic flowchart of a method of identifying a delaying dependency set according to one illustrative embodiment of the invention;

FIG. 5 is a schematic flowchart of a method of identifying a delaying dependency set according to another illustrative embodiment of the invention; and

FIG. 6 is a schematic flowchart of a method of partitioning a trace into dependency sets according to some illustrative embodiments of the invention.

It will be appreciated that for simplicity and clarity of illustration, elements shown in the figures have not necessarily been drawn to scale. For example, the dimensions of some of the elements may be exaggerated relative to other elements for clarity.

### DETAILED DESCRIPTION OF EMBODIMENTS OF THE INVENTION

In the following detailed description, numerous specific details are set forth in order to provide a thorough understanding of embodiments of the invention. However it will be understood by those of ordinary skill in the art that the embodiments of the invention may be practiced without these specific details. In other instances, well-known methods and procedures have not been described in detail so as not to obscure the embodiments of the invention.

Some portions of the following detailed description are presented in terms of algorithms and symbolic representations of operations on data bits or binary digital signals within a computer memory These algorithmic descriptions and representations may be the techniques used by those skilled in the data processing arts to convey the substance of their work to others skilled in the art.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Some embodiments of the invention may be implemented, for example, using a machine-readable medium or article which may store an instruction or a set of instructions that, if executed by a machine, cause the machine to perform a method and/or operations in accordance with embodiments of the invention. Such machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, e.g., memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, various types of Digital Versatile Disks (DVDs), a tape, a cassette, or the like. The instructions may include any suitable type of code, for example, source code, target code, compiled code, interpreted code, executable code, static code, dynamic code, or the like, and may be implemented using any suitable high-level, low-level, object-oriented, visual, compiled and/or interpreted programming language, e.g., C, C++, Java, BASIC, Pascal, Fortran, Cobol, assembly language, machine code, or the like. It may be a proprietary internal language as well.

Embodiments of the invention may include apparatuses for performing the operations herein. These apparatuses may be specially constructed for the desired purposes, or they may include a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROM), random access memories (RAM), electrically programmable read-only memories (EPROM), electrically erasable and programmable read only memories (EEPROM), magnetic or optical cards, or any other type of media suitable for storing electronic instructions, and capable of being coupled to a computer system bus.

The processes and displays presented herein are not inherently related to any particular computer or other apparatus. Various general-purpose systems may be used with programs in accordance with the teachings herein, or it may prove convenient to construct a more specialized apparatus to perform the desired method. The desired structure for a variety of these systems will appear from the description below. In addition, embodiments of the invention are not described with reference to any particular programming language. It will be appreciated that a variety of programming languages may be used to implement the teachings of the invention as described herein.

In the following description, various figures, diagrams, flowcharts, models, and descriptions are presented as different means to effectively convey the substances and illustrate different embodiments of the invention that are proposed in this application. It shall be understood by those skilled in the art that they are provided merely as illustrative samples, and shall not be constructed as limitation to the invention.

In this application, a “race” may refer to a set of instructions of a computer program code. Inter-relationships among instructions of the trace may be represented by a dependency graph as is known in the art. A trace may include one or more dependency chains A “dependency chain” (DC) may refer to a sequence of connected components, e.g., maximally connected instructions represented in a dependency graph of the trace. A “dependency set” (DS) may refer to a sub-set of connected instructions in a trace. A dependency set may be, for example, a dependency chain, but need not to be. For example, a dependency set may be a sub-section of a dependency chain.

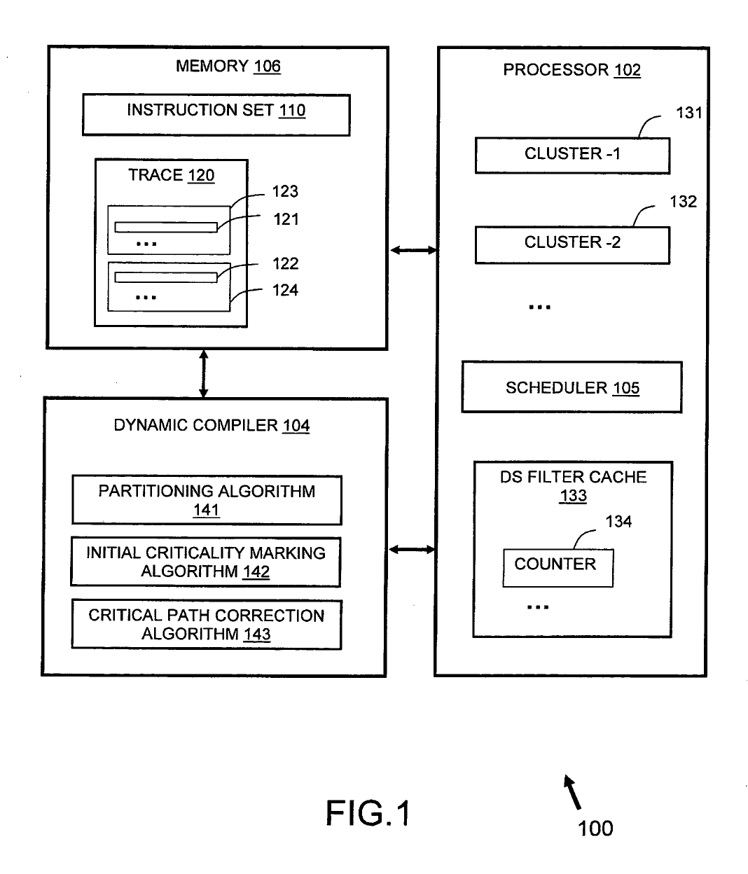

FIG. 1 is a block diagram illustration of an apparatus 100 capable of identifying a critical path of a computer program code according to some illustrative embodiments of the invention. Apparatus 100 may be, for example, a computing platform including a processor 102, a dynamic compiler 104 as described in detail below, and a memory 106. Processor 102, dynamic compiler 104, and memory 106 may be operatively connected.

A non-exhaustive list of examples for apparatus 100 may include a desktop personal computer; a work station, a server computer; a laptop computer, a notebook computer, a hand-held computer, a personal digital assistant (PDA), a mobile telephone, a game console, and the like.

A non-exhaustive list of examples for processor 102 may include a central processing unit (CPU), a digital signal processor (DSP), a reduced instruction set computer (RISC), a complex instruction set computer (CISC) and the like. Moreover, processor 102 may be part of an application specific integrated circuit (ASIC) or may be a part of an application specific standard product (ASSP).

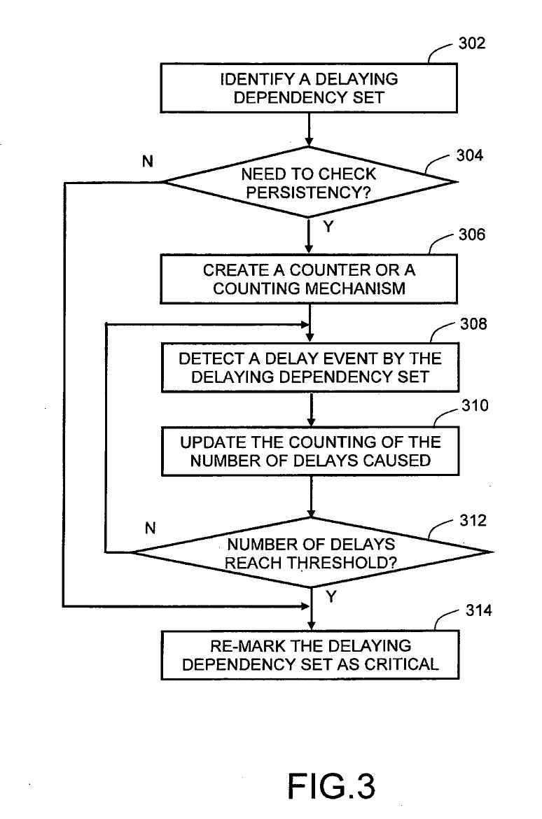

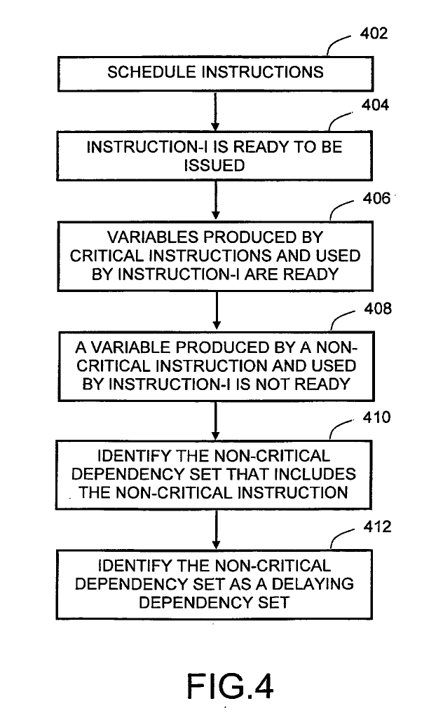

According to illustrative embodiments of the invention, processor 102 may be any type of processors as listed above, and may be, for example, a processor based on a clustered micro-architecture as known in the art. Processor 102, as shown in FIG. 1, may include multiple clustered processing units, referred to herein as clusters, for example, clusters 131 and 132, to execute instructions as described in detail below. Processor 102 may include a scheduler 105 that schedules instructions, for example, instruction set 110, during execution as described in detail below with reference to FIG. 4. Processor 102 may also include a DS filter cache 133 containing one or more counters, for example, a counter 134. Counter 134 may be used count delays caused by a dependency set as described in detail below with reference to FIG. 3

According to illustrative embodiments of the invention, dynamic compiler 104 may be a hardware-based compiler adapted to execute a partitioning algorithm 141, an initial criticality marking algorithm 142, and/or a critical path correction algorithm 143. However, the invention is not limited in this respect and dynamic compiler 104 may be also a memory device having stored thereon program codes that may be executed by processor 102 to implement algorithms 141, 142, and/or 143. Furthermore, memory device 104 may be, for example, a part of memory 106.

A non-exhaustive list of examples for memory 106 may include one or any combination of the following semiconductor devices, such as synchronous dynamic random access memory (SDRAM) devices, RAMBUS dynamic random access memory (RDRAM) devices, double data rate (DDR) memory devices, static random access memory (SRAM) devices, flash memory (FM) devices, electrically erasable programmable read only memory (EEPROM) devices, non-volatile random access memory (NVRAM) devices, universal serial bus (USB) removable memory devices, and the like; optical devices, such as compact disk read only memory (CD ROM), and the like; and magnetic devices, such as a hard disk, a floppy disk, a magnetic tape, and the like. Memory 106 may be fixed within or removable from apparatus 100.

According to illustrative embodiments of the invention, memory 106 may be adapted to store a set of instructions 110. Instruction set 110 may be analyzed during execution to produce one or more traces, for example, a trace 120, which may in turn include one or more dependency sets, for example, dependency sets 121 and 122. Trace 120 may be stored in memory 106 but the invention is not limited in this respect. For example, trace 120 may be stored in a separate cache

According to illustrative embodiments of the invention, processor 102 may be adapted to execute algorithm 141 to partition one or mole instructions of a trace, for example, trace 120, into one or more dependency sets, for example, dependency sets 121 and 122.

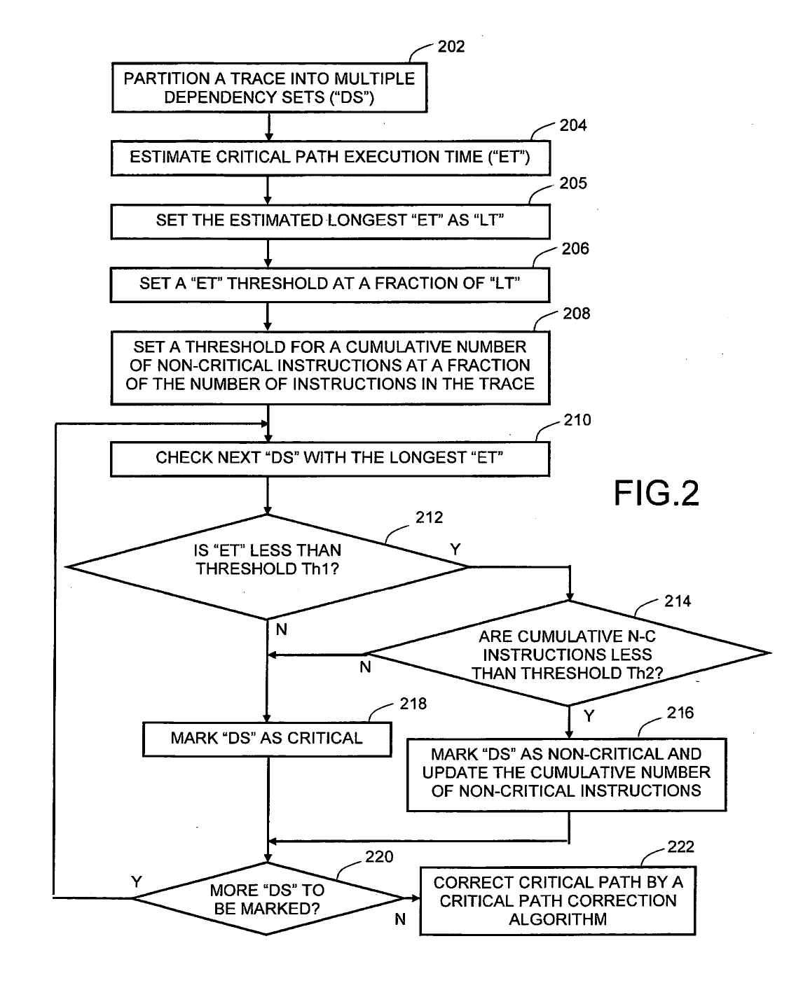

According to illustrative embodiments of the invention, processor 102 may then execute algorithm 142 to identify a first group of dependency sets, for example, a group 123, and mark the group, as well as instructions therein, as critical. Processor 102 may also identify a second group of dependency sets, for example, a group 124, and mark the group, as well as instructions therein, as non-critical. The identification and marking of the first and second groups of dependency sets are described in detail below with reference to FIG. 2.

According to illustrative embodiments of the invention, during scheduling and execution of the set of instructions 120, processor 102 may execute algorithm 143 to detect possible discrepancies between the criticality marking and actual execution of a dependency set. In other words, an initially marked noncritical dependency set may actually be a critical dependency set, causing delays to the execution of other critical dependency sets. A non-critical dependency set causing delays to the execution of other critical dependency sets may be referred to herein as a “delaying dependency set”, and algorithm 143 may re-mark the delaying dependency set, and instructions therein, as critical.

Algorithms 141, 142, and 143 are described in detail below with reference to FIGS. 2-6.

FIG. 2 is a schematic flowchart of a method of partitioning a trace into groups of dependency sets according to some illustrative embodiments of the invention. The groups may include a critical group and a non-critical group.

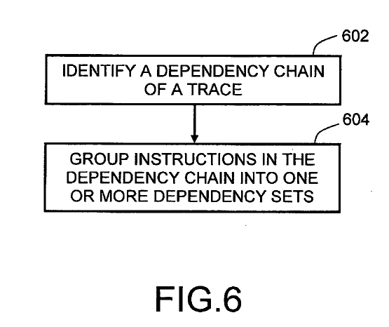

According to illustrative embodiments of the invention, processor 102 may execute partitioning algorithm 141 to partition instructions in a trace into multiple DS's, as indicated at block 202. The partitioning may be based on factors such as, for example, types, dependencies, and/or machine resource requirement of instructions in the trace. For example, partitioning may be based on dependency chains represented by a dependency graph of the trace. Partitioning instructions in a trace is described in detail below with reference to FIG. 6.

Processor 102 may execute instructions inside a DS along multiple execution paths. Execution times of the multiple execution paths of the DS may be estimated. Among the multiple execution paths, a path having the longest estimated execution time, referred to herein as a “critical path” (CP), may be identified and the estimated execution time may be referred to herein as a “critical path execution time” (ET). As indicated at block 204, ET's for DS's inside a trace may be estimated In addition, the longest estimated ET among all the ET's of the DS's in a trace may be referred to herein as the “longest critical path execution time” (LT), as indicated at block 205.

According to illustrative embodiments of the invention, processor 102 may execute initial criticality marking algorithm 142 to identify a DS as belonging to either a critical or a noncritical group based upon predetermined criteria or decision-making thresholds before the trace is executed. A first threshold (“Th1”) may be used to select dependency sets based on their ET's. As indicated at block 206, Th1 may be set to a predefined fraction, for example, 80%, of the LI of the trace. In addition, a second threshold (“Th2”) may be used to set a limit, for example, on the cumulative number of non-critical instructions in the non-critical group. As indicated at block 208, Th2 may be set to a predefined fraction, for example, 60%, of the total number of instructions in the trace.

According to illustrative embodiments of the invention, a processor having a clustered micro-architecture, for example, processor 102, may have multiple clustered processing units, e.g., clusters 131 and 132, that may have difference performance characteristics. For example, cluster 131 may be designed for, for example, high execution speed, and therefore may be a critical cluster. Cluster 132 may be designed for, for example, power saving and therefore may be a non-critical cluster. Non-critical cluster 131 may run at a certain frequency, f_{NC}, which may be lower than the frequency, f_{C}, of critical cluster 132.

Although the invention is not limited in this respect, according to some illustrative embodiments of the invention, thresholds Th1 and Th2 may be defined as follows in a clustered micro-architecture. The first threshold Th1 may be defined or set to a predefined fraction, for example, f_{NC}/f_{C}, of the LT of all the DS's The second threshold Th2 may be set according to the relative execution speed between clusters 131 and 132. For example, the second threshold Th2 may be set to a fraction of the total number of instructions with the fraction being, for example, the execution speed of the non-critical cluster 131 divided by the combined execution speed of the critical cluster 131 and the non-critical cluster 132. The threshold values may be fixed or may change in accordance with program behavior, in which case an adaptive algorithm may be used to set them from time to time.

According to illustrative embodiments of the invention, the dependency sets may be marked as either critical or non-critical as described below, and subsequently be grouped, for example, into two groups according to their respective marking. According to illustrative embodiments of the invention, as indicated at block 210, DS's may be selected for marking according to their ET's in a descending order. For example, a DS may be selected for marking when the DS to be marked has the longest ET among all the DS's that have not yet been marked. However, the invention is not limited in this respect. For example, a DS may be selected for marking when the DS to be marked has the shortest ET among all the DS's that have not yet been marked. If the ET of the DS to be marked is determined to be below threshold Th1, as indicated at block 212, and if at the same time the cumulative number of instructions in all the DS's that have already been marked as non-critical is determined to be below threshold Th2, as indicated at block 214, then the DS to be marked as well as instructions contained therein may be marked as non-critical, as indicated at block 216. Following the marking, the cumulative number of non-critical instruction is updated.

According to illustrative embodiments of the invention, if the ET of the DS to be marked is determined at block 212 to be over threshold Th1, then the DS to be marked may be marked as critical, as indicated at block 218. If the cumulative number of instructions inside the non-critical group of DS's, that is, the cumulative number of non-critical instructions, has already reached threshold Th2, the DS may also be marked as critical as indicated at block 218. Once the cumulative number of non-critical instructions has reached threshold Th2, the remaining DS's may be marked as critical.

As indicated at block 220, the method determines whether there are more DS's that remain to be marked. If there are additional DS's to be marked, the method may return to block 210 to analyze and group a following DS, e.g., a DS having the next longest ET, and repeat the marking procedure as described above. If all the DS's have been marked, the initial criticality marking process may end at block 220

According to illustrative embodiments of the invention, there may be factors such as, for example, inter-trace dependencies and memory misses, as is known in the art, which may have not been addressed in the initial criticality marking process of a dependency set. As a result, during execution, an instruction of a DS marked as non-critical, may actually be identified as causing delays to execution of other instructions of critical DS's. In other words, the DS initially marked as noncritical may actually be on the program's critical path, i.e., be a critical DS, per the above definitions. Therefore, according to illustrative embodiments of the invention, after the initial criticality marking as described in FIG. 2, a DS marked as non-critical may be dynamically re-marked by a correction algorithm 143, as indicated at block 222 and described in detail below with reference to FIG. 3.

FIG. 3 is a schematic flowchart of a method of marking a dependency set from non-critical to critical according to some illustrative embodiments of the invention.

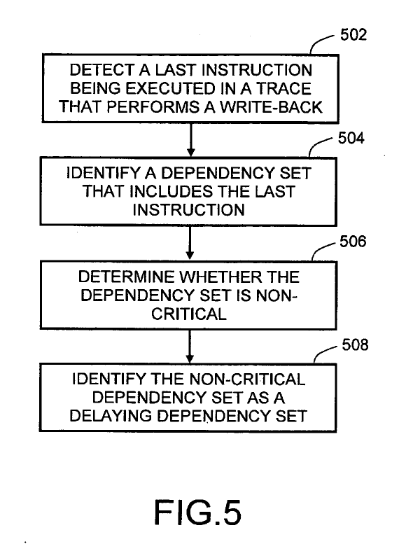

According to illustrative embodiments of the invention, the method may first identify a non-critical DS as being a delaying DS, as indicated at block 302. A delaying DS may be identified or detected, for example, during scheduling of instructions and/or during execution of a write-back operation, as described in detail below with reference to FIGS. 4 and 5.

According to one embodiment of the invention, without checking whether the identified delaying DS persists in causing delays to other critical DS's, as indicated at block 304, the method may re-mark the identified delaying DS as critical, as indicated at block 314 According to another embodiment of the invention, the method may check whether the identified delaying DS persists in causing delays to other critical DS's as indicated at block 304. According to this embodiment, a delaying DS may be remarked as a critical DS only after the delaying DS is confirmed to persist in delaying the execution of other critical DS's frequently, as described below in detail.

According to one embodiment of the invention, a counting mechanism such as, for example, counter 134, may be set to count the number of delays caused by the delaying DS to other critical DS's as indicated at block 306 The counting mechanism, e g., counter 134, may be initially set at a starting value, for example, “1”. When processor 102 detects the delaying DS causes a delaying event to the execution of other critical DS's, as indicated at block 308, the value in counter 134 may be updated by a predefined inclement, as indicated at block 310, e.g., from “1” to “2” in the above example. At block 312, processor 102 may determine whether the number of delays caused by the delaying DS has reached a pre-determined threshold number. If the predetermined threshold number has not been reached, the method may continue counting the delaying events caused by the delaying DS, as indicated at blocks 308 and 310. If the number of delays caused by the delaying DS, as is determined at block 312, reaches or exceeds the threshold, the delaying DS may be re-marked as critical, as indicated at block 314. In subsequent execution, the delaying DS may be executed as a critical DS.

According to illustrative embodiments of the invention, one or more initially marked non-critical DS's may be detected as delaying the execution of other critical DS's during code execution. Therefore, separate counters or counting mechanism may be implemented, e.g., one counter per DS. The counters may be, for example, cache-based counters. The cache tag for each DS may include an identifier of the trace containing the DS and an index of the DS itself. Each time a delay caused by the DS is detected or identified, the number in the counter may be incremented by a predefined value, for example, by 1.

FIG. 4 is a schematic flowchart of a method of identifying a delaying dependency set according to one illustrative embodiment of the invention.

According to illustrative embodiments of the invention, before execution of instructions, scheduler 105, for example, may schedule the instructions as indicated at block 402. At some point in time during the scheduling process, scheduler 105 may be ready to issue an instruction (“Instruction-I”), as indicated at block 404. Instruction-I may use variables produced by some other critical and non-critical instructions. However, at the time scheduler 105 is ready to issue Instruction-I, one or more of the variables used by Instruction-I may not be ready. As indicated at block 406, the method may first make sure that all the variables that are produced by critical instructions of critical DS's are ready. The method may then proceed to identify, as indicated at block 408, at least one variable that is not ready and is produced by a non-critical instruction (“Instruction-J”). At block 410, the method may identify a non-critical DS that the noncritical instruction, i.e., Instruction-J, belongs to. The method may define the non-critical DS as a delaying DS, as indicated at block 412.

FIG. 5 is a schematic flowchart of a method of identifying a delaying dependency set according to another illustrative embodiment of the invention.

According to illustrative embodiments of the invention, during code execution, the method may detect an instruction that is a last instruction of a trace to be executed and performs a write-back operation, as indicated at block 502 The method may then proceed to identify a DS that includes the instruction, as indicated at block 504. The DS may be a critical or a non-critical DS. As indicated at block 506, the method may determine whether the DS is a non-critical DS. If the DS is a non-critical DS, at block 508 the method may identify the DS, which includes the instruction performing the write-back operation, as a delaying DS.

FIG. 6 is a schematic flowchart of a method of partitioning a trace into dependency sets according to some illustrative embodiment of the invention.

A trace may include multiple dependency chains. A dependency chain may be identified by parsing a dependency graph of the trace, as indicated at block 602. According to illustrative embodiments of the invention, instructions in a dependency chain may be grouped as a single dependency set or divided into multiple dependency sets, as indicated at block 604. The one or more dependency sets may subsequently be marked as either critical or non-critical, as described in detail above with reference to FIG. 2.

It will be appreciated by persons skilled in the art that the grouping of instructions as a dependency set is not limited to grouping according to dependency chains. Other grouping policy may be used.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the spirit of the invention.

What is claimed is:

1. A method comprising:
prior to executing a trace, partitioning a series of instructions of said trace into a plurality of dependency sets; and
marking a first group of said dependency sets as critical and a second group of said dependency sets as non-critical.

2. The method of claim 1, wherein one or more of said dependency sets comprises a dependency chain, which includes a sequence of connected instructions in a dependency representation of said trace.

3. The method of claim 1, wherein said marking comprises grouping in said second group one or more of said dependency sets that have a critical path execution time below a time threshold.

4. The method of claim 3, wherein said time threshold is a predefined fraction of a critical path execution time of one of said dependency sets

5. The method of claim 3, wherein grouping in said second group one or more of said dependency sets comprises grouping said one or more dependency sets if a cumulative number of instructions in said second group is below a number threshold.

6. The method of claim 5, wherein said number threshold is a predefined fraction of the total number of said instructions in said trace.

7. The method of claim 3, wherein the critical path execution time of one or more dependency sets in said second group is less than the critical path execution time of one or more dependency sets in said first group.

8. The method of claim 1, further comprising:
identifying at least one delaying dependency set in said second group that delays the execution of at least one dependency set in said first group;
counting the number of delays caused by said delaying dependency set; and
re-marking said delaying dependency set as critical when a predefined delaying event threshold is reached

9 The method of claim 8, wherein identifying said delaying dependency set comprises identifying a last instruction to be executed in said trace that performs a write-back operation and is included in said delaying dependency set.

10. The method of claim 8, wherein identifying said delaying dependency set comprises identifying at least one instruction in said delaying dependency set that is not ready to produce a variable used by a ready-to-issue instruction during instruction scheduling

11. An apparatus comprising:
a dynamic compiler to partition a series of instructions of a trace into a plurality of dependency sets, and to mark a first group of said dependency sets as critical and a second group of said dependency sets as non-critical; and
a processor to execute said plurality of dependency sets based on their markings.

12. The apparatus of claim 11, wherein one or mote of said dependency sets comprises a dependency chain, which includes a sequence of connected instructions in a dependency representation of said trace.

13. The apparatus of claim 11, wherein said marking comprises grouping in said second group one or more of said dependency sets that have a critical path execution time below a time threshold.

14. The apparatus of claim 13, wherein said time threshold is a predefined fraction of a critical path execution time of one of said dependency sets.

15. The apparatus of claim 13, wherein grouping in said second group one or more of said dependency sets comprises grouping said one or more dependency sets if a cumulative number of instructions in said second group is below a number threshold.

16. The apparatus of claim 15, wherein said number threshold is a predefined fraction of the total number of said instructions in said trace.

17. The apparatus of claim 13, wherein the critical path execution time of one or more dependency sets in said second group is less than said critical path execution time of one or more dependency sets in said first group.

18. The apparatus of claim 11, wherein said dynamic compiler is to identify at least one delaying dependency set in said second group that delays the execution of at least one dependency set in said first group; to count the number of delays caused by said delaying dependency set; and to re-mark said delaying dependency set as critical when a predefined delaying event threshold is reached.

19. The apparatus of claim 18, wherein identifying said delaying dependency set comprises identifying a last instruction to be executed in said trace that performs a write-back operation and is included in said delaying dependency set.

20. The apparatus of claim 18, wherein identifying said delaying dependency set comprises identifying at least one instruction in said delaying dependency set that is not ready to produce a variable used by a ready-to-issue instruction during instruction scheduling.

21 A system comprising:
a memory adapted to store a set of instructions, including a series of instructions of a trace;
a dynamic compiler to partition said series of instructions of said trace into a plurality of dependency sets, and to mark a first group of said dependency sets as critical and a second group of said dependency sets as non-critical; and
a processor to execute said plurality of dependency sets based on their markings.

22. The system of claim 21, wherein a critical path execution time of one or more dependency sets in said second group is less than a critical path execution time of one or more dependency sets in said first group.

23 The system of claim 21, wherein said dynamic compiler is to identify at least one delaying dependency set in said second group that delays the execution of at least one dependency set in said first group; to count the number of delays caused by said delaying dependency set; and to re-mark said delaying dependency set as critical when a predefined delaying event threshold is reached.

24. A machine-readable medium having stored thereon a set of instructions that, when executed by a machine, result in partitioning a series of instructions of a trace into a plurality of dependency sets before executing said trace; and marking a first group of said dependency sets as critical and a second group of said dependency sets as non-critical.

25. The machine-readable medium of claim 24, wherein the instructions further result in identifying at least one delaying dependency set in said second group that delays the execution of at least one dependency set in said first group; counting the number of delays caused by said delaying dependency set; and re-marking said delaying dependency set as critical when a predefined delaying event threshold is reached.

26. The machine-readable medium of claim 24, wherein the instructions further result in identifying a last instruction to be executed in said trace that performs a write-back operation and is included in said delaying dependency set.
